(19) United States
(12) Patent Application Publication
(10) Pub. No.: US 2010/0250311 A1
(43) Pub. Date: Sep. 30, 2010

(54) METHOD FOR DETERMINING ACCURATE AMOUNT OF TOTAL EMISSIONS

(75) Inventors: Richard Sandor, Chicago, IL (US); Michael Walsh, Downers Grove, IL (US)

Correspondence Address: WINSTON & STRAWN LLP;PATENT DEPARTMENT, 1700 K STREET, N.W., WASHINGTON, DC, 20006, US

(73) Assignee: Chicago Climate Exchange, Inc.

(21) Appl. No.: 12/813,430

(22) Filed: Jun. 10, 2010

Related U.S. Application Data
(63) Continuation of application No. 11/671,763, filed on Feb. 6, 2007, now abandoned.
(60) Provisional application No. 60/771,028, filed on Feb. 8, 2006.

(51) Int. Cl. G06Q 10/00; G06Q 40/00

(52) U.S. Cl. 705/7

(57) ABSTRACT

A computer-implemented method for determining an accurate amount of total emissions or other attributes of an internal entity within a regulated jurisdiction for a specified time period that includes calculating an amount of emissions or other attributes produced by the internal entity for the specified time period; calculating an amount of emissions or other attributes associated with purchases from other entities for the specified time period; and combining the calculated amounts of emissions or other attributes to yield an amount of total emissions or attributes of the internal entity for the specified time period.

### CROSS-REFERENCE TO RELATED APPLICATIONS

This application is a continuation of application Ser. No. 11/671,763 filed Feb. 6, 2007, which in turn claims the benefit of U.S. provisional application No. 60/771,028 filed Feb. 8, 2006, the content of each of which is expressly incorporated herein by reference.

### FIELD OF THE INVENTION

The present invention relates generally to methods for determining accurate amounts of total emissions or other attributes. The invention further relates to methods for determining emission reductions and conducting trades among participants in a cap-and-trade system.

### BACKGROUND OF THE INVENTION

Programs established to limit the release of pollutants in a cost-efficient manner sometimes employ the “cap and trade” mechanism. This mechanism sets an overall emission limit (the “cap”) that must be achieved collectively by the facilities that release the designated pollutant, but allows those facilities to “trade” amongst themselves in order to achieve the environmental objective at lower cost. Cost savings arise when some facilities find it less expensive to make emission reductions than others (and all such facilities are deemed to be contributors to a pollution problem that has broad geographic impact), and those facing lower cost to curtail emissions in fact reduce emissions to levels below those allowed by the limitation program. Trade and cost-savings are then realized when a facility facing a high cost to reduce emissions purchases “credits” from those who make extra cuts. Each facility operator in the cap-and-trade system must, on a regularly scheduled basis, surrender to the program administrator a quantity of credits that corresponds to the total amount of pollutants released from that facility. This procedure is called “true-up.” When an entity buys credits from another, it positions itself as prepared to comply with the periodic true-up, and finds it economically advantageous to procure surplus credits from others as a substitute for the costlier option of reducing its own emissions.

In order to achieve the environmental objective of an emission cap-and-trade system, program designers typically seek to maximize the coverage of the program so that all or most emissions of the type being limited are in fact subject to the limitation system and effectively limited. Similarly, environmental goals of such an emission limitation program can be impaired if entities subject to the limits are able to relocate business activities in a manner that avoids the emission limits, thus resulting in emissions being moved around but not sufficiently reduced.

This phenomenon, known as emissions “leakage,” can arise when a program to limit emissions is applied to emission sources in some locations but not others, typically as a result of jurisdictional boundaries, e.g., state or national borders. Leakage can arise due to relocation of emitting facilities to jurisdictions that do not impose limits on the targeted pollutant. Leakage can also occur though shifting of purchase activities so that production is curtailed at the facilities subject to the emission limits, and the operator of such facilities replaces such lost output through purchase of goods or services produced in locations not subject to the emission limits. As noted above, leakage can reduce the environmental effectiveness of the emission limits, while also introducing the possibility of undesirably causing uneven economic impacts on entities subject to emission limits. That is, one entity subject to such limits may find it both possible and economically advantageous to “comply” with emission limits by shifting its industrial activity to a location not subject to emission limits, while other entities subject to limits may not have this option.

Examples of differing regulatory regimes that can provide the setting for leakage include international borders where the neighboring regimes do not have the same environmental limits (e.g., the U.S. and Mexico), but can also include subnational boundaries such as state and city boundaries. One example of differential regulatory treatment is found in the context of limits on air emissions associated with the enhanced greenhouse effect (sometimes referenced as “greenhouse gases” and the attendant possibility of “global warming”).

As of January 2005, member states of the European union became subject to a cap-and-trade mechanism to limit emissions of carbon dioxide (a prominent greenhouse gas) while entities located elsewhere are not subject to such limits. One example of leakage may occur in the cement manufacturing industry, which combusts fossil fuels and thereby releases carbon dioxide emissions. If in response to the European Union (EU) emission limits, some cement manufacturers choose to reduce production activity in Europe and, to replace such lost production, choose to raise production levels at their plants in, say, Africa or the United States (where carbon dioxide emissions are not subject to such limits), then the overall environmental effectiveness of the EU emission limit is impaired.

Thus, there is a need for an improved method of accurately determining the total emissions for an entity that allows realization of emission reduction objectives and reduction of emissions leakage.

### SUMMARY OF THE INVENTION

The invention relates to a computer-implemented method for determining an accurate amount of total emissions or other regulated attribute for an internal entity within a regulated jurisdiction for a specified time period, wherein each step is conducted by a computer. This method comprises calculating a first amount of emissions or attributes for which the internal entity is directly responsible for the specified time period; calculating a second amount of emissions or attributes for the internal entity based on emissions or other attributes associated with consumption or purchases of activities, services or products acquired from other entities (hereinafter “purchases”) for the specified time period; and combining the first and second amounts of emissions or other attributes to yield a total amount of emissions or other attributes for the internal entity for the specified time period within the regulated jurisdiction.

The other entities typically comprise known external entities, anonymous entities, or both. The method can be applied to calculate emissions comprising greenhouse gas emissions or other environmental contaminants, or to calculate attributes wherein the attributes comprise taxes, customs duties, or contents of purchased activities, products, goods or services.

In these methods, the purchases often comprise one or more purchases of activities, products or services that result in release of emissions. The calculation of the amount of emissions associated with purchases from known external entities can be made by determining the quantity of purchases from each known external entity; determining an emission rate for the purchases from each known external entity; and multiplying the quantity of purchases from each external entity by the respective emission rate to determine the quantity of emissions from each known external entity. The method may also include combining the calculated amounts of emissions from each known external entity to yield a total amount of emissions from the known external entities. The same can be made for calculating other regulated attributes.

The calculation of the amount of emissions associated with purchases from anonymous entities can be made determining the quantity of purchases from anonymous external entities; establishing an emission rate for the purchases; and calculating the amount of emissions by multiplying the emission rate by the quantity of purchases. The determination of the quantity of purchases from anonymous external entities can include determining the total quantity of purchases from all anonymous entities; determining an external share of the total quantity of purchases; and multiplying the total quantity of all purchases by the external share to yield the quantity of purchases from anonymous external entities. Also, the calculation of the external share can be made by determining the total quantity of purchases of an activity, good or service by all internal entities within the jurisdiction during the specified time period; determining the total quantity of the subject activity, good or service produced within the jurisdiction during the specified time period; subtracting the total quantity produced from the total quantity purchased, and dividing the result by the total quantity purchased. The same can be made for calculating other regulated attributes.

In this method, the activities, products, or services comprise one or more of liquid, gaseous, or solid fuels; chemicals; cement; electronic equipment; agricultural and food products; vehicles; electric power; metals; building materials; aircraft transportation services; and assembly facilities.

The invention also relates to a computer-implemented method for determining reductions of emissions or other regulated attributes for an internal entity within a regulated jurisdiction for a specified time period, wherein each step is conducted by a computer. This method comprises establishing a baseline amount of the emissions or other attributes for a prior time period; determining an accurate amount of total emissions or other attributes for the internal entity according to one of the methods disclosed herein; and comparing the amount of total emissions or other attributes to the baseline amount to determine whether the emissions or other attributes have been reduced.

The establishment of the baseline amount can be done by calculating a first amount of emissions or other attributes produced by the internal entity is directly responsible for the prior time period; calculating an amount of emissions or other attributes for the internal entity based on emissions or other attributes associated with purchases from other entities for the prior time period; and combining the first and second amounts of emissions or other attributes to yield an amount of total emissions of the internal entity for the prior time period. The method of claim 13, wherein the amount of total emissions or other attributes can be reduced by a specified percentage of the baseline amount or can be reduced on the basis of emissions or other attributes per unit of product produced or service delivered.

Another embodiment of the invention is a cap-and-trade system that incorporates the prior method. The invention also relates to a computer-implemented method of conducting trades among participants in such a cap-and-trade system, wherein each step is conducted by a computer. This method comprises issuing tradable allowances for emissions or other attributes; quantifying expected rates of external emissions or other attributes and external shares of purchases that result in emissions or other attributes; determining actual external rates of emissions or other attributes and external shares of the purchases; and collecting from each internal entity a quantity of allowances for emissions or other attributes that correspond to each internal entity's total amount of emissions or other attributes.

In this method, when the total amount of emissions or other attributes is less than the issued allowances for emissions or other attributes, the internal entity may sell its excess allowances or store the excess allowances as credits for future use. Alternatively, when the total amount of emissions or other attributes is more than the issued allowances for emissions or other attributes, the internal entity will buy allowances or credits from another entity to achieve its reduction.

### BRIEF DESCRIPTION OF THE DRAWINGS

FIG. 1 is a graphical representation of an applicable setting for use of the present invention in the context of electric power generation;

FIG. 2 summarizes the methods for quantification of the total emissions inventory of an internal entity according to the present invention;

FIG. 3 summarizes methods for quantification of purchases associated with known entities according to the present invention;

FIG. 4 summarizes methods for quantification of purchases associated with anonymous entities according to the present invention; and

FIG. 5 provides a schematic summary of the implementation of a cap-and-trade system according to the present invention.

### DETAILED DESCRIPTION OF THE PREFERRED EMBODIMENTS

The present invention relates to a computer-implemented method for determining an accurate amount of total emissions or other attributes of an internal entity within a regulated jurisdiction for a specified time period. The method includes calculating an amount of emissions or other attributes produced by the internal entity for the specified time period, calculating an amount of emissions or other attributes associated with purchases from other entities for the specified time period, and combining the calculated amounts of emissions or other attributes to yield an amount of total emissions or other attributes of the internal entity for the specified time period. Generally, the emissions include greenhouse gas emissions or other environmental contaminants, including all pollutants released to the environment (air, water, ground).

The method may be used to establish comprehensive quantification of the total energy use (both internal use and energy use associated with production of purchased goods and services) and, as well, in the administration of taxation, customs and content rules (e.g., in determining the percentage of a product that is produced abroad, or the percentage of a product that has certain important attributes).

The other entities typically include known external entities, anonymous entities, or both. Calculation of the amount of emissions may be associated with purchases from known external entities. The calculation involves determining emission rates for each external entity and multiplying the emission rates by quantity of activities, products or services purchased from each external entity to determine the amount of emissions from each external entity.

In a variation of the invention, the method further includes combining the calculated amounts of emissions from each external entity to yield a total amount of emissions from the external entities. Preferably, the amount of emissions associated with purchases from anonymous entities is also calculated. This calculation includes determining quantity of external purchases from anonymous entities, establishing an emission rate for the purchases, and calculating the amount of emissions by multiplying the emission rate by the quantity. The determination of the quantity of external purchases can include determining total quantity of purchases from anonymous entities, determining an external share of the total quantity of purchases, and multiplying the total quantity by the external share to yield the quantity of external purchases. These purchases generally include one or more purchases of activities, products or services that result in release of emissions. Examples of these activities, products, or services include one or more of liquid, gaseous, or solid fuels; chemicals; cement; electronic equipment; agricultural and food products; vehicles; electric power; metals; building materials; aircraft transportation services; and assembly facilities. In a preferred embodiment, the activities, products, or services include electric power.

In yet another embodiment, the method further includes establishing a total emission baseline with the goal of reducing an amount of emissions from the total.

The method may also be used for determining emission reductions for an internal entity within a regulated jurisdiction for a specified time period. This determination includes establishing a baseline amount of total emissions for a prior time period, determining an accurate amount of total emissions of the internal entity, and comparing the amount of total emissions to the baseline amount to determine whether emissions have been reduced.

This determination also preferably includes accounting for emission credits and emission allowances. Establishment of the baseline amount typically includes calculating an amount of emissions produced by the internal entity for the prior time period, calculating an amount of emissions associated with purchases from other entities for the prior time period, combining the calculated amounts of emissions to yield an amount of total emissions of the internal entity for the prior time period, and determining the baseline amount based on the amount of total emissions for the prior time period. In an advantageous embodiment, the amount of total emissions are reduced by specified percentages of the baseline amount, or are configured by other methods, such as emissions per unit of product produced.

A cap-and-trade system that incorporates the method is also encompassed by the invention. Preferably, the method is used in a computer-implemented method of conducting trades among participants in the cap-and-trade system. The conducting of trades includes issuing tradable emission allowances; quantifying expected external emission rates and external shares of purchases of activities, products or services that result in release of emissions; determining actual external emission rates and external shares of the purchases; and collecting from each internal entity a quantity of emission allowances that correspond to each internal entity's total amount of emissions (both internal and external).

In one embodiment, the total amount of emissions is less than the issued emission allowances, and the internal entity sells its excess emission allowances or stores the excess allowances as credits for future use. In another embodiment, the total amount of emissions is more than the issued emission allowances, and the internal entity buys emission allowances or credits from another participant in order to achieve compliance with the emission reduction requirement.

The present invention provides a mechanism for accounting for (and including in an emission limitation system) any emissions that may otherwise be “leaked” to the detriment of the overall environmental effectiveness of the pollution limitation program. The present invention determines accurate amounts of total emissions released to the natural environment (air, water, or ground) as a result of both directly observed emitting activities (e.g., from on-site fuel use—sometimes referred to as direct emissions) as well as pollutants associated with production of purchased goods or services (off-site or “indirect” emissions).

The present invention is intended to be applicable to a broad range of economic activities and products the production of which results in the release of emissions that may be subject to limitations in some jurisdictions but not others. Those activities, products and services include, but are not limited, to one or more of liquid, gaseous and solid fuels (such as jet fuel, gasoline, natural gas, coal), electricity production, chemicals, cement, electronic equipment, agricultural and food products, vehicles, electric power, metals, building materials, aircraft transportation services, and assembly facilities.

The present methods are also applicable in the determination of total amounts of an attribute (e.g., “foreign” content of an assembled product, genetically modified content in a food product) contained in a product or service. The methods may be useful in the administration of taxes, customs duties, content rules, etc.

Accordingly, the present invention involves computer-implemented methods for determining an accurate amount of total emissions of an internal entity within a regulated jurisdiction for a specified time period. The method includes calculating an amount of emissions produced by the internal entity for the specified time period, calculating an amount of emissions associated with purchases of goods and services from other entities for the specified time period, and combining the calculated amounts of emissions to yield an amount of total emissions of the internal entity for the specified time period. The method allows for comprehensive quantification of emissions caused by the entity, and also captures “leaked” emissions through the calculation of emissions associated with the purchases of goods and services from other entities. As used herein, “internal” refers to an entity that is subject to an emissions limitation program, while “external” refers to an entity that is not subject to the limitation program.

The method allows for proper allocation of ownership of emissions and comprehensive accounting for emissions as well. These features introduce the ability to better achieve environmental goals of a cap-and-trade system, while also facilitating proper contracting and pricing of goods and services that are associated with emissions subject to limits.

For example, one country adopts an emission limit while a neighboring country does not, and economic activity is shifted from the internal, emission-limited jurisdiction to the neighboring country. In another example, one or more states within a country may choose to place limits on emissions released by in-state entities, while a significant (and changeable) amount of total emissions attributable to activities of in-state entities in fact occur out-of-state due to production activities associated with the import into the regulated state of the goods and services, such as fuel and electricity.

The present invention also introduces various methods for determining the accurate, entire emission footprint of an entity subject to limits on total greenhouse gases (or other) emissions associated with both its activities that directly result in such emissions (e.g., as a result of on-site combustion of fuels) within the geographic area covered by the emissions and those associated with energy, materials, fuels, other goods and services produced in a location or by activities that are outside the geographic area covered by the emission limits or outside the range of activities covered by the limits. The methods presented herein allow for sound pricing of emission liabilities and helps provide proper price signals as to the emission cost associated with production, transfer and usage of such materials, goods and services.

Of particular interest are emissions that include greenhouse gas emissions. Greenhouse gases, such as water vapor, carbon dioxide, tropospheric ozone, nitrous oxide, and methane, are generally transparent to solar radiation but opaque to longwave radiation, thus preventing longwave radiation energy from leaving the atmosphere. The net effect of greenhouse gases in the atmosphere is a trapping of absorbed radiation and a tendency to warm the planet's surface. Thus, the reduction of greenhouse gas emissions (or slowing of their growth) remains a significant global environmental goal.

As but one example among the many covered by the present methods, an entity that distributes electric power to end-users both produces its own electricity for distribution and purchases electricity for distribution from other generators, some of which are internal entities. The other generators also typically include known external entities, anonymous entities, or both.

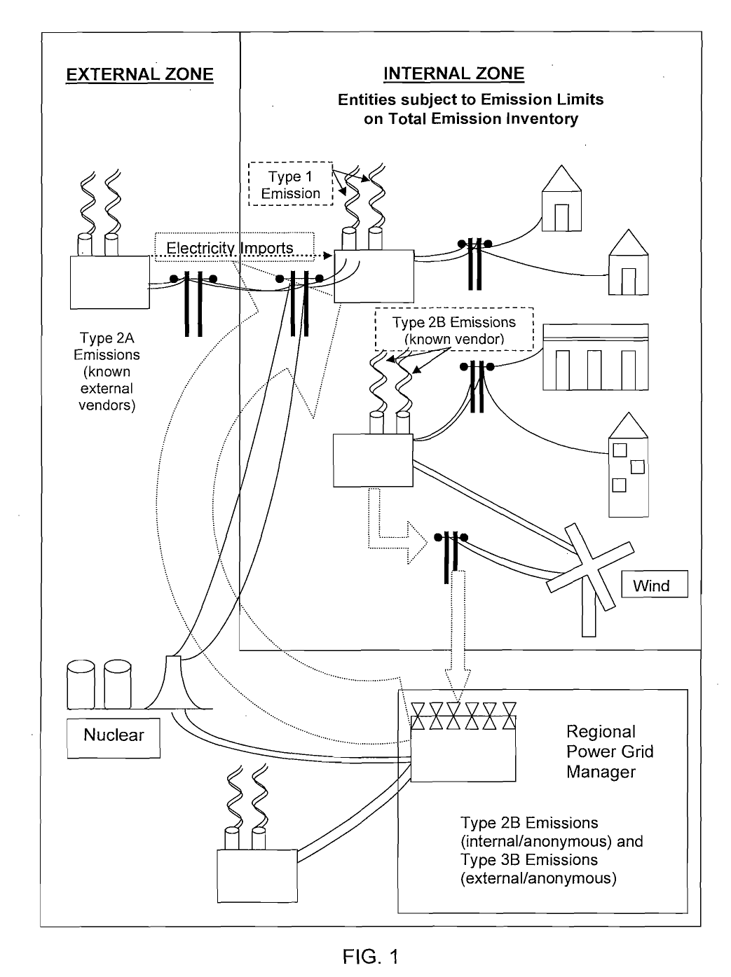

For instance, a political jurisdiction elects to establish limitations on carbon dioxide and/or other greenhouse gas emissions that are associated not only with electric power generated by internal entities that operate electric power generation facilities within that jurisdiction, but also accounts for the emissions released by external entities that operate power generation facilities located outside the jurisdiction and sell electricity into the regulated jurisdiction. In some cases the internal entity will know the identity of the external entity while in other cases electricity is purchased in a manner that does not allow the purchaser to know the identity of the external power producer. i.e., the entity is anonymous. FIG. 1 provides a graphical representation of the setting in which the present innovation is applicable in the context of electric power generation. The circumstances include electric power transactions involving internal entities who are identified when trading, internal entities who transact power anonymously (with coordination provided by the regional grid manager) and electricity imports from both known and anonymous external entities.

As one of the many possible examples of the problems that are solved by the present innovation, the common setting characterized in FIG. 1 introduces accounting and pricing problems. In the present method, entities that purchase electric power from external entities must include in their Total Emission Inventory (“TEI) emissions associated with externally produced electric power. The method provides for comprehensive coverage of emissions related to internal activities, thus ideally preventing leakage and equity problems. In the context of a regional wholesale electric power grid that covers both internal and external entities, proper ownership of emission footprints, contracting to reduce emission liabilities associated with emissions embedded in purchased power, and proper pricing of electric power (inclusive of carbon emission liabilities) cannot succeed unless all entities involved in purchase and sale of wholesale power are able to accurately determine the carbon emissions embedded in purchased power. The presently described methods provide a means of clearly assigning and tracking carbon emissions embedded in purchased power in a setting where a large number of power generators and purchasers are involved.

It is important to emphasize that the methods presented herein are intended to establish a specific rule-based methodology for accurately determining the full emissions inventory in, for example, the electricity market circumstances described herein. While this rules-based methodology provides a functional method, there is not an agreed single definition of a methodology that can be defined as the sole “correct” method. The methods cover a broad class of methods that can be modified depending on the nature of available data. Thus the methods described herein represent a functional means of addressing the emissions associated with economic activity undertaken by an entity subject to limitations on both its internal activities and the activities it fosters through procurement from production sources outside the geographic range of the enforced emission limits. As such, it provides a functional method that consistently employs formulae to quantify the complete emission inventory.

For internal entities that distribute electric power to customers, the three types of possible electricity-related emissions to be quantified and managed under the regulatory system are: (1) emissions resulting from the entity's own generation, that is emissions from fossil-fueled facilities owned by the electricity distributor (which can be located both internally and externally); (2) emissions associated with electricity purchased from internal and external entities whose identities are known by the internal power purchaser; and (3) emissions associated with anonymous grid-purchased power. Traders and other entities regularly purchase and re-sell, repackage and otherwise arrange for further delivery of electric power from one entity to others, with the involved entities sometimes wishing to stay anonymous for the purpose of avoiding the disclosure of trading strategies, pricing matters, etc. In addition, regional electricity grid managers can in some cases instruct certain power generators to produce electricity and deliver it onto the grid (for compensation) in order to address unmet demand and grid system imbalances.

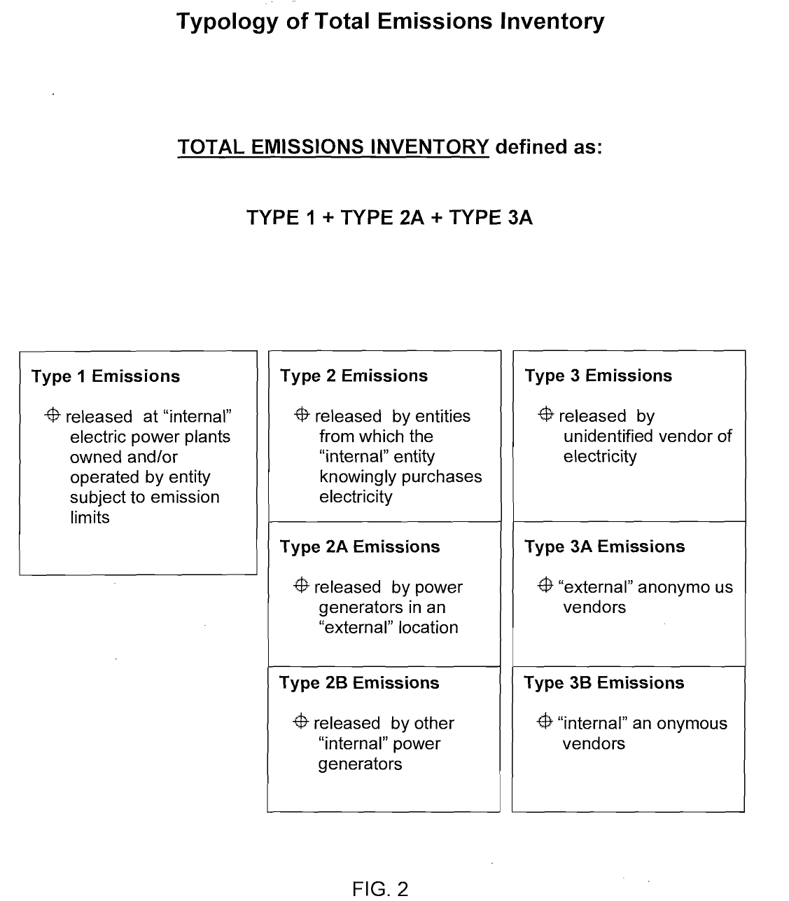

One aspect of the present methods provides definitions and methodologies for quantifying these three types of emissions involved in the total emissions of electric power distributing entities. As summarized in FIG. 2, the methods define the Total Emissions Inventory (“TEI”) of each electric power distributor within the regulated internal jurisdiction as the sum total of: (1) emissions associated with fossil fuel combusted at the internal entity's own plants or Type 1 Emissions; (2) emissions associated with all electricity purchases from entities whose identities are known to the internal entity that purchases such electricity or Type 2 Emissions; and (3) emissions associated with electricity purchased from entities whose identities are not known to the internal entity that purchases such electricity or Type 3 Emissions.

Type 2 Emissions have two components: (1) emissions associated with electricity purchased by internal entities from external entities or Type 2A Emissions; and (2) emissions associated with electricity purchased by internal entities from internal entities or Type 2B Emissions. Similarly, Type 3 Emissions have two components: (1) emissions associated with electricity produced by external entities or Type 3A Emissions; and (2) emissions associated with electricity produced by internal entities or Type 3B Emissions.

It is important to emphasize that there can be a variety of electricity generating facilities in both the internal and external regions. This variety can include units that have relatively high rates of emissions (emissions per unit of production, with “production” typically considered to be megawatt-hours of electricity generated) such as coal-fired power plants, as well as units with lower emission rates such a units fired by combustion of natural gas, and zero-emission units such as nuclear, wind, and hydroelectric power. In addition, the production levels at these various types of generating units can fluctuate over time and from year to year, thus causing changes in the overall emission rate (total emissions divided by total electricity produced in a region). This reality introduces a complexity in determining TEIs for entities that acquire electricity from other generators. The present methods, however, provide systematic methods for working within this context.

The present invention provides methods for establishing historic, anticipated and actual quantities of Type 2 Emissions and Type 3 Emissions in the presence of imperfect information on which electric power generating units provided electricity to internal entities who are subject to emission limits and must include emissions associated with electricity produced by external power plants. The invention also provides methods for incorporating these emissions into a cap-and-trade system.

Generally, in some circumstances it could be the case that all electric power that is transferred from a generator to a purchaser is “tagged” so that the identity of the original producer of the electricity is known in all transactions. In this case, the quantities of Type 3 Emissions are zero, resulting in total emissions equal to the sum total of Type 1 Emissions plus Type 2A Emissions.

Type 2B Emissions are typically excluded from the TEI of the purchasers of power as those emissions are incorporated into the cap-and-trade program as a result of being included in the emission inventory of other internal electric power generators that sell electricity to others. As a general matter, quantification of Type 1 Emissions is to be conducted using established methodologies (e.g., continuous emission monitors, use of fuel-specific emission factors and fuel combustion quantities).

Type 2A Emissions are usually calculated by determining emission rates for each external entity, and multiplying the emission rates by quantity of activities, products or services purchased from each external entity to determine the amount of emissions from each external entity. Type 2A emissions rates are typically to be calculated for each seller of wholesale electric power according to the following equation:
Total emissions released from the facilities of the external electric power generator during the regulatory period (typically a calendar year), in metric tons of carbon dioxide equivalent
   Divided by
Total electricity produced by the entity (in megawatt-hours) during the regulatory period

Using this emission rate, the electricity purchaser will then calculate Type 2A Emissions from each entity it purchased electricity from as the product of
{emission rate_{entity i}}multiplied by {total quantity of electricity purchased from entity I}
   Then, total Type 2A Emissions are to be calculated as the sum of the Type 2A Emissions associated with all electricity purchased from external entities, as expressed in the following equation:

Σᵢ (i representing all vendors)=Emission Rateᵢ×Quantity of electricity purchasedᵢ

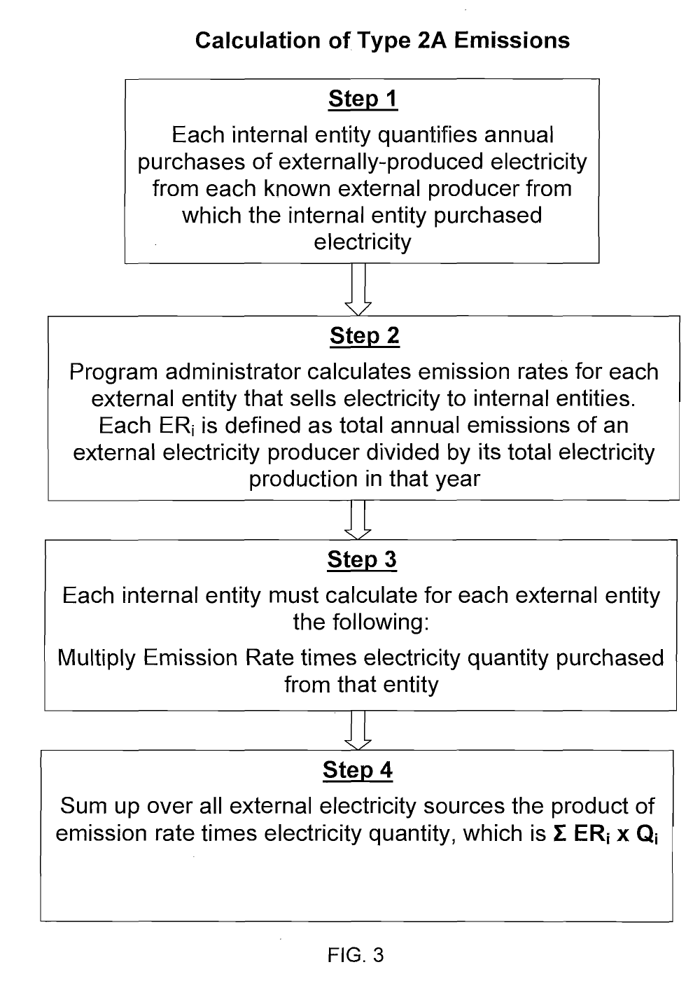

FIG. 3 summarizes the methods established for this procedure.

Importantly, the present methods solve a potential accounting accuracy problem associated with the concept of “contract shuffling” by external entities. This arises when an external entity that sells to the internal entity nominally dedicates the delivery of output of lower emitting power generators to the internal entity, leaving the output of the higher emitting power plants to be sold to other external entities, without actually reducing overall emissions of the external entity that generates electricity. By using the comprehensive emissions footprint of external vendors, the possible effects of “contract shuffling” are avoided.

Some of the electricity purchased by internal entities may be produced by entities that are not identified to the purchaser or by those that are anonymous. This can arise as a result of the efforts of electricity brokers, who arrange for the delivery of electricity on the transmission grid by a seller of electricity in an amount corresponding to the quantity of electricity sought by the purchaser, with the broker arranging to serve as intermediary for payment flows from buyer to seller. Acquisition of electricity on an anonymous basis can also arise as a result of the procedures employed by regional electricity transmission grid operators.

Calculation of the amount of emissions associated with these types of purchases should also be included in the TEI. This calculation includes determining quantity of external purchases from these anonymous entities, establishing an emission rate for the purchases, and calculating the amount of emissions by multiplying the emission rate by the quantity.

For anonymously purchased electricity, the internal buyer needs to account for emissions associated with electricity purchased from external entities (both Type 2A and 3A Emissions). The present methods provide a consistent and replicable methodology for quantifying such emissions.

There are three quantities that must be determined to calculate total emissions associated with anonymous electricity purchases: (1) quantity of anonymously purchased electricity that is produced externally; (2) emission rates to be assigned to those electricity purchases; and (3) quantity of total electricity purchases that are purchased on an anonymous basis. It is important to note that proper operation of the cap-and-trade system requires that the above quantities be set for the baseline period that establishes the quantity of emissions that is used as a reference in setting the emission limitation schedule. Furthermore, as explained further below, these values must be established prospectively for establishment of expected emission quantities associated with anonymous electricity purchases, and retrospectively so that actual emission quantities can be determined once actual electricity importation quantities and associated emission rates are known.

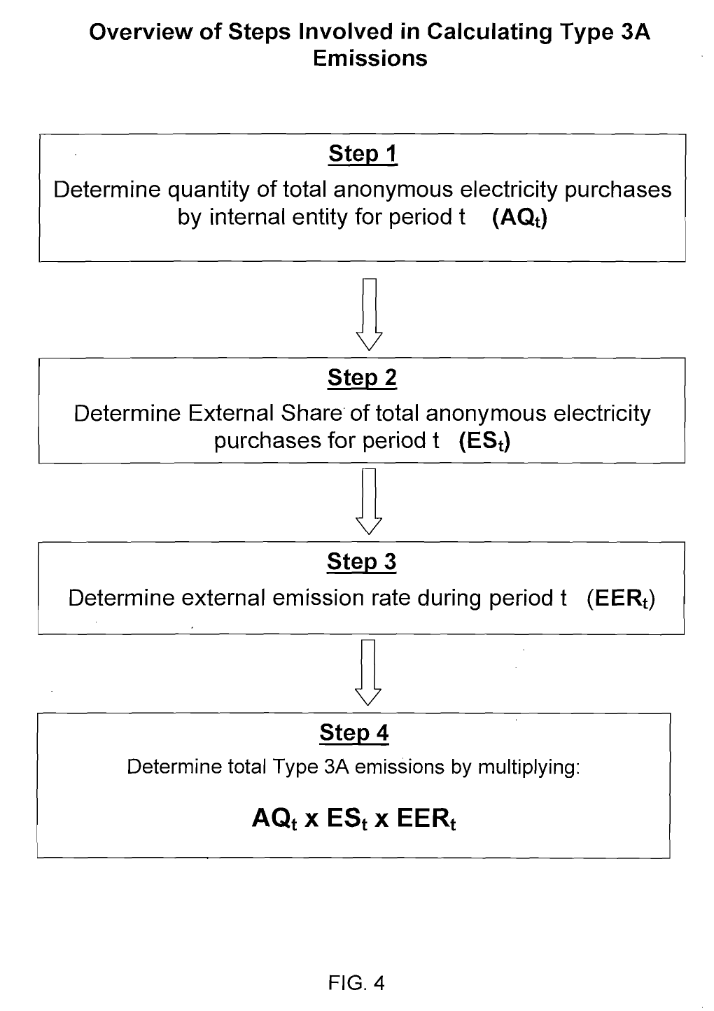

The method employs a four-step process for determining the emissions to be assigned to the TEI of each internal buyer of anonymously produced electricity. FIG. 4 summarizes the steps involved in applying the method.

The first step requires the internal entity to determine the total quantity of its purchased electricity that is acquired from anonymous sources (e.g., through brokers, or though assignments of grid operations managers) during time period t, which is designated herein as AQₜ.

The second step is to employ the methods described below to determine the External Share (ESₜ) of purchased electricity. This is the quantity of externally produced electricity during time period t relative to total electricity purchased within the jurisdiction. This External Share is defined herein as:
{Total quantity of electricity purchased during a year within the jurisdiction subject to emission limit
   Minus
Total quantity of electricity produced during a year within the jurisdiction subject to the emission limit}
   This total then
   Divided by
Total quantity of electricity purchased during a year within the jurisdiction subject to the emission limit
   As an example, if total purchase of electric power during a year is one billion megawatt hours (mwh), and total production of electricity that year within the jurisdiction subject to the emission limit is eight hundred million megawatt hours, then the share of purchased electricity that is produced externally is:

ES={1 billion mwh−0.8 billion mwh}/1 billion mwh=20%

The third quantity to be established is the Emission Rate (EERₜ) to be assigned to external electricity purchases during period t.
The EERₜ quantity is defined as:
Total emissions released during time period t for all electricity productions facilities that are external to the emissions-limited jurisdiction but are within the total electricity transmission pool(s) connected to the emissions-limited jurisdiction
   Divided by
Total electricity produced during that time period by electricity productions facilities that are external to the emissions-limited jurisdiction but are within the total electricity transmission pool(s) connected to the emissions-limited jurisdiction
   As an illustration, if total emissions released during specified time period t for all electricity productions facilities that are external to the emissions-limited jurisdiction but are within the total electricity transmission pool(s) connected to the emissions-limited jurisdiction are three hundred million tons, and total electricity produced during that same period by electricity production facilities that are external to the emissions-limited jurisdiction but are within the total electricity transmission pool(s) that is connected to the emissions-limited jurisdiction are five hundred million megawatt-hours (mwh), then the emission rate to be assigned to external electricity purchases is:

EERₜ=300,000,000 divided by 500,000,000=0.60 tons of emissions per megawatt-hour produced.

For each internal entity that purchases electricity on an anonymous basis, the quantity of electricity that is defined to be produced externally is
Total quantity of anonymous electricity purchases (AQₜ)
   Multiplied by
the share of purchased electricity that is produced externally relative to total electricity purchased within the jurisdiction (the External Share (ESₜ))
   As one example, if an entity purchases one million megawatt-hours of electricity on an anonymous basis, and the share of purchased electricity that is produced externally relative to total electricity consumed within the jurisdiction is determined (in accordance with the above provisions) to be 20%, then the quantity of anonymously purchased electricity that is defined as being externally produced is:
one million megawatt-hours (AQₜ)
   multiplied by
   0.20 (ESₜ)
Which equals 200,000 mwh
   Completing the example, the total emissions that would be included in the emissions inventory of the hypothetical entity and circumstances described by the above-quantities would be:
the quantity of anonymously purchased electricity that is defined as being externally produced (AQₜ×ESₜ)
   Multiplied by
the emission rate to be assigned to external electricity purchases (EERₜ which is the particular examples developed above is
   200,000 mwh
   Multiplied by
   0.6 tons per mwh
   Which equals
   120,000 tons of emissions
      FIG. 4 summarizes this method.

The method typically also includes establishing a total emission baseline with the goal of reducing an amount of emissions from the total. One use of the cap-and-trade emission limitation system is to set a reference quantity of emissions—often referred to as the “baseline”-using historic quantities of emissions associated with each entity subject to the emission limitation system. Such a baseline is often then used to define the emission limitation schedule that is set relative to the baseline.

The TEI includes both the emissions released directly by all other entities subject to the emissions limitation system, as well as external emissions that are caused by electricity purchases undertaken by internal entities. The emission baseline is generally a quantity defined as an average of an entity's total emission level over multiple years, with total emissions defined as per the different types of emissions established above.

For purposes of illustration, assume the baseline emission level is defined as the average total emissions during years 1 and year 2, as follows:
{Entity's Total Emission Inventory during year 1, expressed in tons
   plus
Entity's Total Emission Inventory during year 2, expressed in tons}
   This sum then
   Divided by
   Two.
      As an example of establishing a baseline for a single entity having Types 1, 2, and 3 Emissions above, Table 2 below demonstrates the methodology to be employed.

To include the emissions associated with electricity purchased from external entities into the entity's TEI during the baseline period, it is necessary to calculate Type 2A and Type 3A Emissions.

Table 1 provides an example of the calculation of Type 2A Emissions for year 1 and year 2. The example assumes the internal entity has purchased electricity from two external vendors (Vendor 1, Vendor 2) in each of the two years of the baseline period.

TABLE 1
Type 2A Emissions Associated with Electricity
Purchases from Known External Vendors

| | | Vendor 1 | | Vendor 2 | |
|---|---|---|---|---|---|
| Year 1 | Electricity | 1,000,000 | mwh | 2,000,000 | mwh |
| | purchased | | | | |
| | Emission rate | 0.4 | tons/mwh | 0.8 | tons/mwh |
| | Total emissions | 400,000 | tons | 1,600,000 | tons |
| Year 2 | Electricity | 800,000 | mwh | 3,000,000 | mwh |
| | purchased | | | | |
| | Emission rate | 0.5 | tons/mwh | 0.7 | tons/mwh |
| | Total emissions | 400,000 | tons | 2,100,000 | tons |

Year 1 Grand Total Emissions: 2,000,000 tons Associated with Electricity Purchases from Known External Vendors
Year 2 Grand Total Emissions: 2,500,000 tons Associated with Electricity Purchases from Known External Vendors

Type 3A Emissions in year 1 and year 2 are assumed to be the quantity derived earlier (120,000 tons). Type 1 emissions for this example are shown in Table 2, which illustrates calculation of the TEI using the examples developed above.

TABLE 2

| Emission type | Year 1 | Year 2 | 2-year total | 2-year average |
|---|---|---|---|---|
| Type 1 | 3,000,000 | 4,000,000 | 7,000,000 | 3,500,000 |
| Type 2A | 2,000,000 | 2,500,000 | 4,500,000 | 2,250,00 |
| Type 3A | 120,000 | 120,000 | 240,000 | 120,000 |
| Total | 5,120,000 | 6,620,000 | 11,340,000 | 5,870,000 |

In this example, the baseline TEI of the entity to be affected by the emission limitation system is 5,870,000 tons.

Preferably, the administrator of the emission limitation program establishes an emission limit for multiple years that is defined as a specified percentage of the emission baseline. For example, the annual emission limit could be set at about 1% to 4% below the historic baseline level of emissions that each internal entity experienced. In some cases the program may elect to employ differentiated emission limits by industry or entity type, or may define the reduction on other bases, such as emissions per unit of delivered electricity. In addition, the program administrator may elect to define the TEI in a manner that includes one or multiple types of emissions associated with goods or services produced in other jurisdictions.

The cap-and-trade emission system described herein may include a registry, a guarantee mechanism, and a trading host or platform. The system can be coupled to a network, such as the Internet or any other public or private network or connections of computing devices. The system can also be communicatively coupled to an emissions database, either directly or via the network.

The registry holds emission allowances, but can also hold other types of instruments representing quantities of environmental (or other) attributes, Carbon Financial Instruments, such as exchange allowances (XAs), exchange emission offsets (XOs) generated by mitigation projects, and exchange early action credits (XEs) reflecting “early” emission reductions. In an implementation, each instrument represents one hundred metric tons of CO₂ and is designated with a specific annual vintage. Each of these instruments is recognized as equivalent when surrendered for compliance (which may be subject to certain constraints), and Carbon Financial Instruments may be used in compliance in their designated vintage year or in later years.

In an exemplary embodiment, the registry is designed to provide secure Internet access by entities or participants to their own accounts. The registry may be configured to provide access of accounts by the public, but this access would be on a read-only basis. Preferably, the registry is configured with the ability to interface with registries in other greenhouse gas markets. The registry is linked to the trading platform and financial guarantee mechanism. The combination of these three components provides a clearinghouse system.

The guarantee mechanism enhances market performance by ensuring that those who conduct sales of Carbon Financial Instruments on the trading platform receive next-day payment even if the buyer fails to execute the payment process. This mechanism allows for anonymous trading by eliminating the need to address the credit worthiness of buyers. Non-payment risk is eliminated, thus removing a transaction cost. This feature allows the participation in trading by liquidity providers (including “market makers”), who can stand ready to promptly buy and sell. The presence of standing buyers and sellers increases trading activity, which improves the economic efficiency of the price discovery process. In addition, the ability to trade anonymously allows members to post bids and offers and execute trades without revealing their trading strategies. The guarantee mechanism eliminates the risk that a buyer may fail to make payment.

The trading platform is an electronic mechanism for hosting market trading that provides participants with a central location that facilitates trading, and publicly reveals price information. The trading platform reduces the cost of locating trading counter parties and finalizing trades, an important benefit in a new market.

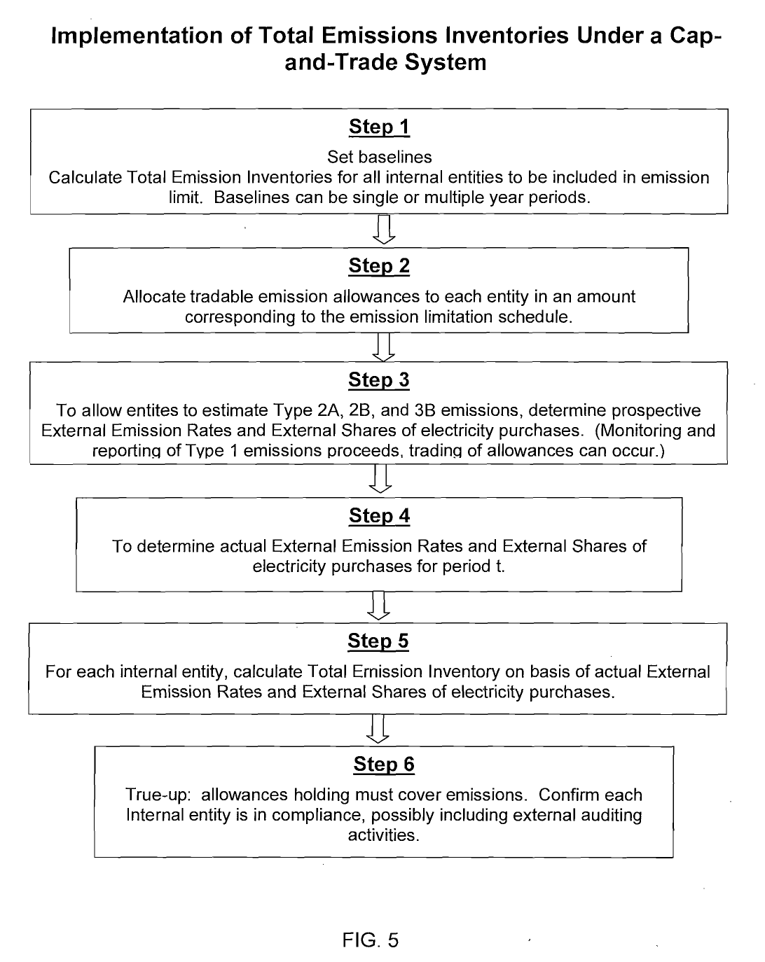

Consistent with the methods already described, the framework here includes a generic cap-and-trade structure involving TEIs that include emissions associated with externally produced electric power that is imported into the jurisdiction covered by the cap-and-trade program. FIG. 5 provides a schematic summary of the method.

Once the program administrator selects the emission baseline period and emission limits, the first step in implementing the methods established herein is to quantify the baseline for each internal entity by calculating the TEI during the specified baseline period (e.g., the average TEI during the years 1998 through 2001).

The second step includes the issuance of tradable emission allowances that represent, as an example, one metric ton of carbon dioxide emissions. Allowances are issued to each internal entity in an amount corresponding to its applicable emission limits, and a multi-year stream of allowances can be issued in accordance with the multi-year set of emission limits. Issuance of allowances could be done electronically through a system of computerized registry accounts, or could take the form of secured paper certificates.

The third step is to quantify, using the methods established above, expected External Emission Rates and External Shares of electricity purchases. These quantities can be formulated on the basis of recent historical averages, e.g., the average of these values for the most recent three-year period. Publication of these quantities will allow internal entities that purchase electric power from other known external entities and/or anonymous entities to make estimates what the impact of such purchases will have on their TEI, and make economic decisions in accordance with such information.

This method is an important innovation as it allows the system to inform entities involved in power purchases to ascribe estimated emission liabilities to electricity purchases when such actual emission liabilities cannot be known until after-the-fact. Establishment of such a “prospective” emission rate and “prospective” imported electricity share allows internal entities to make reasonably sound decisions as to the desirability and fair price for electricity purchased from external vendors, taking into account emissions (and their economic value) associated with such purchase.

Throughout the time period covered by the baseline and the life of the emission limitation system, all internal entities and external sources of electric power are presumed to be quantifying their own Type 1 Emissions, as these numeric values are needed to calculate all the quantities that are part of the TEI. In addition, entities subject to the emission limits (and other entities) may transfer for consideration emission allowances established by the program. As described below, such allowances are an integral element of the process of confirming conformance with the emission limitation system.

The fourth step occurs subsequent to the end of the time period used to define emission limits, typically (but not always) a calendar year. As soon as practicable after the end of that period the program administrator collects all data needed to determine actual External Emission Rates and External Shares of electricity purchases during the limitation period. These values are then used by all affected internal entities to quantify TEIs in accordance with the methods described above (the fifth step).

The sixth step involves “true up” and requires the program administrator to collect from each internal entity that is subject to the emission limit a quantity of emission allowances that corresponds to each entity's TEI during the specified time period. This calculation typically involves accounting for emission credits and emission allowances in the total quantity of emissions. Credits may be earned, for example, by reducing emissions or by participation in environmentally friendly activities, such as planting trees or removing pollutants from a stream. Those internal entities that reduce emissions below the required levels can sell or bank their excess emissions allowances for future use, while those with emissions above the reduction goal run up a debit and must purchase emission allowances or credits from another participant in order to achieve compliance. The program administrator may choose to require an independent audit of each internal entity's TEI, and may similarly choose to employ such audit professionals as part of the program.

Note any of the functions, method steps or processes of the invention can be performed by one or more hardware or software devices, processes or other entities. These entities can reside in the same location or can reside remotely as, for example, entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps or processes.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product, which can cause a general-purpose computer to operate as a special-purpose computer, in accordance with the disclosure herein. Such program product implemented on a general-purpose computer constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of configuration parameters which are often unique to the operating system(s) used by the computer. When so configured, the special-purpose computer device has an enhanced value, especially to the professional users for whom it may be intended.

It is to be understood that the terms “computer,” “server,” “data storage means,” as well as cognate terms, denote either physical or logical instances of those entities. For instance, a computer, data storage means and server may be implemented as separate physical entities or as one physical entity performing logically separate functions. Similarly two servers may be implemented as separate physical entities or as one physical entity performing logically separate functions. Also, a computer may be envisaged as a “terminal” which will be understood to include mobile devices (e.g. mobile phones or PDAs) as well as stationary computers.

It should be understood that the embodiments presented herein are merely examples according to the invention. While some of the equations refer to electricity that is purchased, the calculations can instead be made on the basis of consumption rather than purchase. Furthermore, while electricity was used as an example of a commodity purchase, the equations also apply to other activities, products or services on the basis of consumption. Although particular embodiments have been chosen to illustrate the invention, it will be understood by those of ordinary skill in the art that various changes and modifications can be made without departing from the spirit and scope of the invention as defined by the claims.

What is claimed is:

1. A computer-implemented method for determining an accurate amount of total emissions or other regulated attribute for an internal entity within a regulated jurisdiction for a specified time period, wherein each step is conducted by a computer, which method comprises:
calculating a first amount of emissions or attributes for which the internal entity is directly responsible for the specified time period;
calculating a second amount of emissions or attributes for the internal entity based on emissions or other attributes associated with consumption or purchases of activities, services or products acquired from other entities (hereinafter “purchases”) for the specified time period; and
combining the first and second amounts of emissions or other attributes to yield a total amount of emissions or other attributes for the internal entity for the specified time period within the regulated jurisdiction.

2. The method of claim 1, wherein the other entities comprise known external entities, anonymous entities, or both.

3. The method of claim 2, applied to calculate emissions comprising greenhouse gas emissions or other environmental contaminants.

4. The method of claim 3, wherein calculation of the amount of emissions or other regulated attributes associated with purchases from known external entities comprises:
determining the quantity of purchases from each known external entity;
determining an emission or regulated attribute rate for the purchases from each known external entity; and
multiplying the quantity of purchases from each external entity by the respective rate to determine the quantity of emissions or other regulated attributes from each known external entity.

5. The method of claim 2, which further comprises combining the calculated amounts of emissions or other regulated attributes from each known external entity to yield a total amount of emissions or other regulated attributes from the known external entities.

6. The method of claim 2, wherein calculation of the amount of emissions or other regulated attributes associated with purchases from anonymous entities comprises:
determining the quantity of purchases from anonymous external entities;
establishing an emission or regulated attribute rate for the purchases; and
calculating the amount of emissions or other regulated attributes by multiplying the rate by the quantity of purchases.

7. The method of claim 2, applied to calculate attributes wherein the attributes comprise taxes, customs duties, or contents of purchased activities, products or services.

8. The method of claim 7, wherein the determination of the quantity of purchases from anonymous external entities comprises:
determining the total quantity of purchases from all anonymous entities;
determining an external share of the total quantity of purchases; and
multiplying the total quantity of all purchases by the external share to yield the quantity of purchases from anonymous external entities.

9. The method of claim 8, wherein the calculation of the external share comprises:
determining the total quantity of purchases of an activity, good or service by all internal entities within the jurisdiction during the specified time period;
determining the total quantity of the subject activity, good or service produced within the jurisdiction during the specified time period;
subtracting the total quantity produced from the total quantity purchased, and dividing the result by the total quantity purchased.

10. The method of claim 9, wherein the activities, products, or services comprise one or more of liquid, gaseous, or solid fuels; chemicals; cement; electronic equipment; agricultural and food products; vehicles; electric power; metals; building materials; aircraft transportation services; and assembly facilities.

11. A computer-implemented method for determining reductions of emissions or other regulated attributes for an internal entity within a regulated jurisdiction for a specified time period, wherein each step is conducted by a computer, which method comprises:
establishing a baseline amount of the emissions or other attributes for a prior time period;
determining an accurate amount of total emissions or other attributes for the internal entity according to the method of claim 1; and
comparing the amount of total emissions or other attributes to the baseline amount to determine whether the emissions or other attributes have been reduced.

12. The method of claim 11, wherein establishment of the baseline amount comprises:
calculating a first amount of emissions or other attributes produced by the internal entity is directly responsible for the prior time period;
calculating an amount of emissions or other attributes for the internal entity based on emissions or other attributes associated with purchases from other entities for the prior time period; and
combining the first and second amounts of emissions or other attributes to yield an amount of total emissions of the internal entity for the prior time period.

13. The method of claim 12, wherein the amount of total emissions or other attributes are required to be reduced by a specified percentage of the baseline amount or on the basis of a specified percentage of emissions or other attributes per unit of product produced or service delivered.

14. A cap-and-trade system that incorporates the method of claim 1.

15. A computer-implemented method of conducting trades among participants in the cap-and-trade system of claim 14, wherein each step is conducted by a computer, which method comprises:
issuing tradable allowances for emissions or other attributes;
quantifying expected rates of external emissions or other attributes and external shares of purchases that result in emissions or other attributes;
determining actual external rates of emissions or other attributes and external shares of the purchases; and
collecting from each internal entity a quantity of allowances for emissions or other attributes that correspond to each internal entity's total amount of emissions or other attributes.

16. The method of claim 15, wherein the total amount of emissions or other attributes is less than the issued allowances for emissions or other attributes, and the internal entity sells its excess allowances or stores the excess allowances as credits for future use.

17. The method of claim 15, wherein the total amount of emissions or other attributes is more than the issued allowances for emissions or other attributes, and the internal entity buys allowances or credits from another entity.
